(19) United States
(12) Patent Application Publication
(10) Pub. No.: US 2023/0175732 A1
(43) Pub. Date: Jun. 8, 2023

(54) COMBUSTION CHAMBER FOR WATER HEATER, WATER HEATER INCLUDING THE SAME, AND METHOD FOR MANUFACTURING COMBUSTION CHAMBER

(71) Applicant: KYUNGDONG NAVIEN CO., LTD., Gyeonggi-do (KR)

(72) Inventors: Jun Kyu PARK, Seoul (KR); Tae Seong KWON, Seoul (KR)

(73) Assignee: KYUNGDONG NAVIEN CO., LTD., Gyeonggi-do (KR)

(21) Appl. No.: 18/060,240

(22) Filed: Nov. 30, 2022

(30) Foreign Application Priority Data
Dec. 3, 2021 (KR) 10-2021-0172166

(51) Int. Cl. F24H 1/20

(52) U.S. Cl. CPC F24H 1/206

(57) ABSTRACT

Disclosed are a combustion chamber for a water heater, a water heater including the same, and a method for manufacturing the combustion chamber. The combustion chamber for a water heater includes a first part, of which a first diameter that is a diameter of an upper end thereof is larger than a second diameter that is a diameter of a lower end thereof, a second part, of which a diameter of an upper end is the same as the second diameter and of which a third diameter that is a diameter of a lower end thereof is smaller than the second diameter, and a third part, of which an upper end is connected to the lower end of the first part and of which a lower end is connected to the upper end of the second part.

### CROSS-REFERENCE TO RELATED APPLICATION

This application claims the benefit of priority to Korean Patent Application No. 10-2021-0172166 filed in the Korean Intellectual Property Office on Dec. 3, 2021, the entire contents of which are incorporated herein by reference.

### TECHNICAL FIELD

The present disclosure relates to a combustion chamber for a water heater, a water heater including the same, and a method for manufacturing the combustion chamber.

### BACKGROUND

In general, in a water heating device such as a boiler or a water heater, a combustion chamber that causes a combustion reaction to generate hot water is formed. Among them, in a conduit type water heater, water around a conduit that extends downwards is heated while exhaust gas generated in a combustion chamber disposed on an upper side flows along the conduit.

However, when a capacity of the water to be heated is high, it is preferable to use a cylinder type burner instead of a flat plate type burner to increase an area of a flame generation surface. Because flames are generated on one surface in the flat plate type burner whereas flames are generated on a side surface of a cylinder in the cylinder type burner, the cylinder type burner is suitable for high capacity as it is easy to increase an area of a flame generation surface. Because an upward/downward length of the cylinder type burner is larger than that of the flat plate type burner, the cylinder type burner requires a combustion chamber having a large upward/downward length. The combustion chamber is mainly formed through a drawing scheme, and it is difficult to apply the drawing scheme due to a limit in properties of a material when the combustion chamber having a large upward/downward length is formed.

Furthermore, water is filled outside the combustion chamber, and because corner portions of the conventional combustion chamber is angled, stresses generated by the water are not distributed uniformly whereby anti-water pressure performance is not good.

### SUMMARY

The present disclosure has been made to solve the above-mentioned problems occurring in the prior art while advantages achieved by the prior art are maintained intact.

An aspect of the present disclosure provides a combustion chamber for a water heater, in which a cylinder type burner may be disposed in an interior thereof, a water heater including the same, and a method for manufacturing the combustion chamber.

An aspect of the present disclosure also provides a combustion chamber for a water heater, in which stresses generated by water may be distributed uniformly, a water heater including the same, and a method for manufacturing the combustion chamber.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a combustion chamber for a water heater provided in the water heater for heating water and that provides a space, in which a burner that causes a combustion reaction for heating the water is disposed includes a first part, of which a first diameter that is a diameter of an upper end thereof is larger than a second diameter that is a diameter of a lower end thereof, a second part, of which a diameter of an upper end is the same as the second diameter and of which a third diameter that is a diameter of a lower end thereof is smaller than the second diameter, and a third part, of which an upper end is connected to the lower end of the first part and of which a lower end is connected to the upper end of the second part.

A diameter of the first part may increase as it goes to an upper side, and a diameter increment rate that is a rate, at which the diameter per unit height increases, may increase as it goes to the upper side.

The first part may be curved.

A diameter of the second part may increase as it goes to an upper side, and a diameter increment rate that is a rate, at which the diameter per unit height increases, may decrease as it goes to the upper side.

The second part may be curved.

The first part and the second part may be formed by cutting and separating a cutting targeted object that is a single body.

The third part may be coupled to the lower end of the first part and the upper end of the second part after the cutting targeted object is cut and separated into the first part and the second part.

The cutting targeted object may be formed by pressing an upper surface of a flat plate downwards.

A plurality of holes, through which exhaust gas generated through the combustion reaction is discharged, may be formed on a lower surface of the second part.

According to another aspect of the present disclosure, a water heater includes a tank that keeps water, a combustion chamber provided in the tank, and that provides a space, in which a combustion reaction for heating the water is caused, and a burner provided in the combustion chamber and that causes the combustion reaction, and the combustion chamber may be formed by coupling three parts of the combustion chamber, which are divided along an upward/downward direction, and a diameter of an upper end of the combustion chamber may be larger than a diameter of a lower end thereof.

According to another aspect of the present disclosure, a method for manufacturing a combustion chamber includes pressing an upper surface of a flat plate downwards to make a cutting targeted object having a shape that is opened upwards, cutting the cutting targeted object along one surface that is perpendicular to an upward/downward direction to form a first part and a second part, and coupling a third part between the first part and the second part.

### BRIEF DESCRIPTION OF THE DRAWINGS

The above and other objects, features and advantages of the present disclosure will be more apparent from the following detailed description taken in conjunction with the accompanying drawings:

FIG. 1 is a view conceptually illustrating a water heater including a combustion chamber for a water heater according to an embodiment of the present disclosure;

FIG. 2 is a view conceptually illustrating a combustion chamber for a water heater according to an embodiment of the present disclosure;

FIG. 3 is a partially enlarged view of FIG. 1;

FIG. 4 is a view conceptually illustrating a combustion chamber, in which a flat plate type burner is disposed in an interior thereof;

FIG. 5 is a view conceptually illustrating a process of manufacturing a combustion chamber for a water heater according to an embodiment of the present disclosure; and

FIG. 6 is a view illustrating comparison of stress analysis results when a first part does not have a curvature and when a first part has a curvature.

### DETAILED DESCRIPTION

Hereinafter, some embodiments of the present disclosure will be described in detail with reference to the exemplary drawings. In providing reference numerals to the components of the drawings, the same components may have the same reference numerals even if they are displayed on different drawings. Further, in the following description of the present disclosure, a detailed description of known functions and configurations incorporated herein will be omitted when it may make the subject matter of the present disclosure rather unclear.

Combustion Chamber 4 for Water Heater

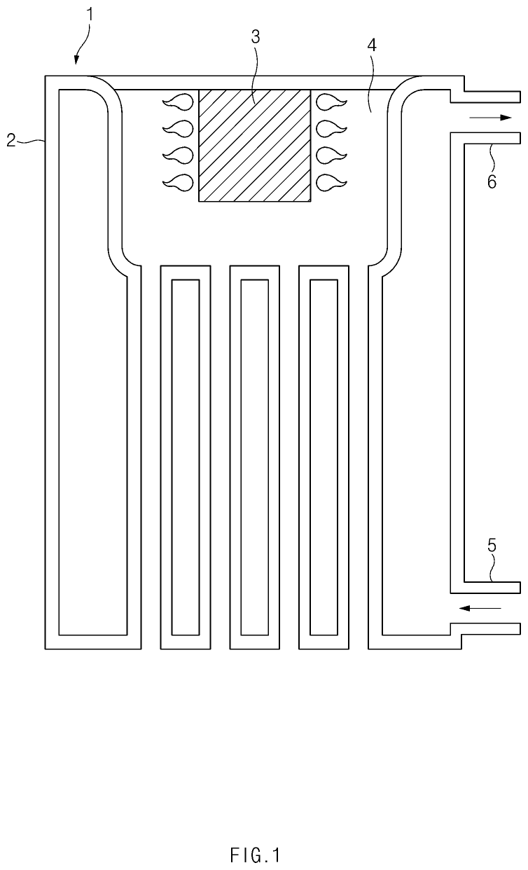

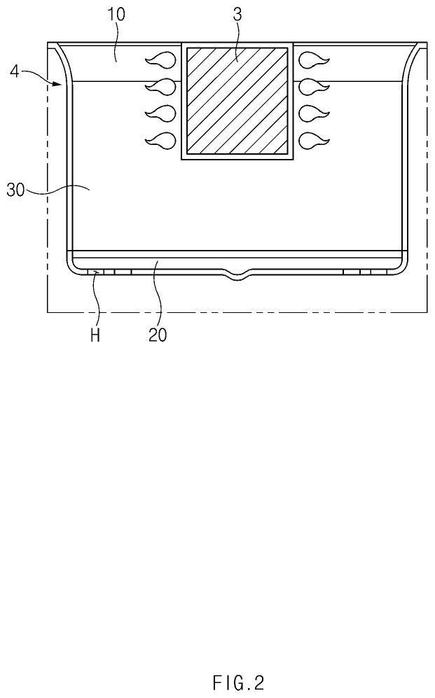

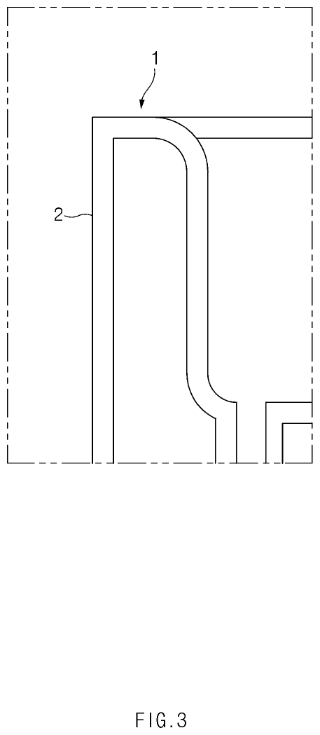

A combustion chamber 4 for a water heater according to an embodiment of the present disclosure relates to the combustion chamber 4 for a water heater that is provided in a water heater 1 for heating water and provides a space, in which a burner 3 that causes a combustion reaction for heating the water is disposed. FIG. 1 is a view conceptually illustrating a water heater including a combustion chamber for a water heater according to an embodiment of the present disclosure. FIG. 2 is a view conceptually illustrating the combustion chamber for a water heater according to an embodiment of the present disclosure. FIG. 3 is a partially enlarged view of FIG. 1.

As illustrated in FIG. 2, the combustion chamber 4 for a water heater according to an embodiment of the present disclosure may include a first part 10, a second part 20, and a third part 30.

The first part 10 may refer to a part, of which a first diameter that is a diameter of an upper end thereof is larger than a second diameter that is a diameter of a lower end thereof. Here, the diameter may refer to an outer diameter. In FIG. 2, the first part 10 may refer to an upper part of an entire part that constitutes the combustion chamber 4. The first part 10 may have a shape that is opened in an upward/downward direction.

A diameter of the first part 10 may increase as it goes to an upper side. Furthermore, in the first part 10, a diameter increment rate that is a rate, at which the diameter per unit height increases, may increase as it goes to the upper side. The first part 10 may be curved.

The second part 20 may refer to a part, of which a diameter of an upper end thereof is the same as the second diameter and of which a third diameter that is a diameter of a lower end is smaller than the second diameter. In FIG. 2, the second part 20 may refer to a lower part of an entire part that constitutes the combustion chamber 4.

A diameter of the second part 20 may increase as it goes to the upper side. Furthermore, a diameter increment rate of the second part 20 may decrease as it goes to the upper side. The second part 20 may be curved.

As illustrated in FIG. 2, because the first part 10 and the second part 20 are curved, corners of the combustion chamber are curved whereby stresses generated by water may be uniformly distributed and thus an anti-water pressure performance may become better.

The second part 20 may have a shape that is opened upwards. A plurality of holes “H” may be formed on a lower surface or the second part 20. Exhaust gas generated through the combustion reaction may be discharged through the plurality of holes “H”.

The third part 30 may refer to a part, of which an upper end is connected to the lower end of the first part 10 and of which a lower end is connected to the upper end of the second part 20. In FIG. 2, the third part 30 may refer to an intermediate part of the entire part that constitutes the combustion chamber 4. An upward/downward length of the third part 30 may be larger than an upward/downward length of the burner 3. The third part 30 may have a shape that is opened in the upward/downward direction.

In the combustion chamber for a water heater according to an embodiment of the present disclosure, because the third part 30 is disposed between the first part 10 and the second part 20, the burner having a large upward/downward length may be disposed in an interior thereof.

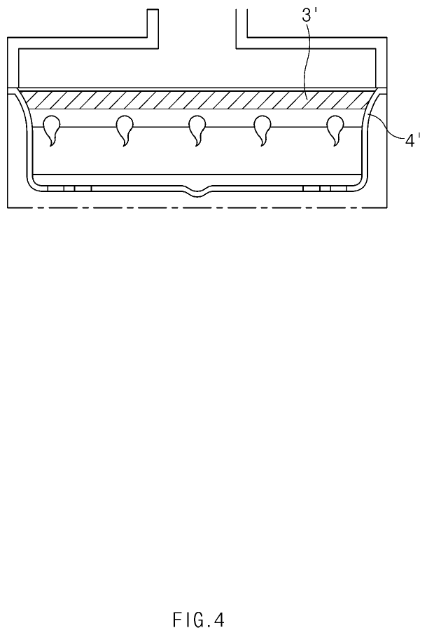

FIG. 4 is a view conceptually illustrating a combustion chamber 4′, in which a flat plate type burner 3′ is disposed in an interior thereof. For example, as illustrated in FIG. 4, in the case of the combustion chamber 4′ that has only shapes corresponding to the first part 10 (FIG. 2) and the second part 20 (FIG. 2) but does not have a part corresponding to the third part 30 (FIG. 2), only the flat plate type burner 3′ may be disposed in an interior thereof, and thus heating performance may deteriorate.

In the combustion chamber for a water heater according to an embodiment of the present disclosure, a cylinder type burner having a large upward/downward length as well as the flat plate type burner may be disposed. The cylinder type burner has a higher heating performance than the flat plate type burner, a heating performance of the water heater may be enhanced.

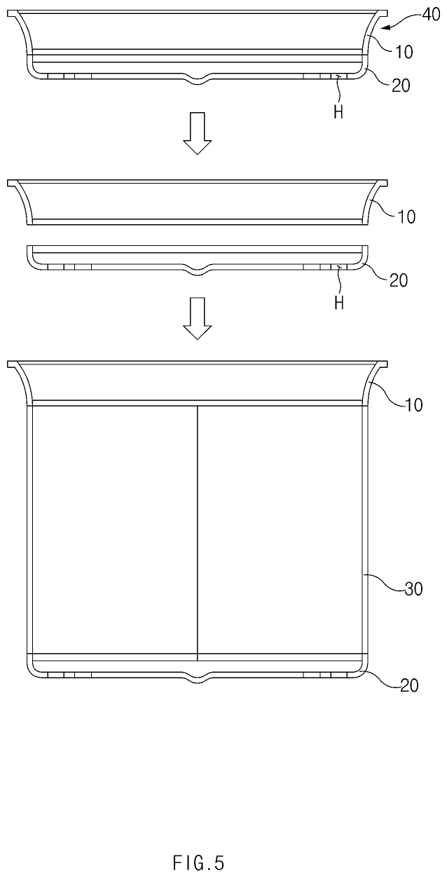

FIG. 5 is a view conceptually illustrating a process of manufacturing a combustion chamber for a water heater according to an embodiment of the present disclosure. As illustrated in FIG. 5, the first part 10 and the second part 20 may be famed by cutting and separating a cutting targeted object 40 that is a single body. The cutting targeted object 40 may be formed through a drawing scheme. The drawing scheme may refer to a scheme of machining a material by pressing an upper surface of the material downwards.

The third part 30 may be coupled to the lower end of the first part 10 and the upper end of the second part 20 after the cutting targeted object 40 is cut and separated into the first part 10 and the second part 20. The coupling may be seamed welding, but the present disclosure is not limited thereto.

For example, a method for forming the first part 10 and the second part 20 may be considered through drawing schemes, respectively, while a single body is neither cut nor separated. In this case, a mold for drawing the first part 10 and a mold for drawing the second part 20 are separately necessary, and thus, production costs may increase.

According to the combustion chamber 4 for a water heater according to an embodiment of the present disclosure, because the first part 10 and the second part 20 are formed by forming one cutting targeted object 40 through a drawing scheme and then cutting it, production costs may be reduced.

According to the combustion chamber 4 for a water heater according to an embodiment of the present disclosure, because the first part 10 and the second part 20 are formed by forming one cutting targeted object 40 through a drawing scheme and then cutting it, a thickness of the combustion chamber 4 for a water heater may become uniform as compared with the case, in which the first part 10 and the second part 20 are famed separately.

Furthermore, because the combustion chamber 4 for a water heater according to an embodiment of the present disclosure is formed through a drawing scheme, the curved shapes of the first part 10 and the second part 20 may be formed according to necessary curvatures. Accordingly, because the stresses generated by the water may be distributed uniformly, and thus anti-water pressure performance may be enhanced. As an example, a radius of curvature of the first part may be 30R to 40R.

Furthermore, because the stresses generated by the water are distributed uniformly, a thickness of the combustion chamber 4 for a water heater itself may be made thin.

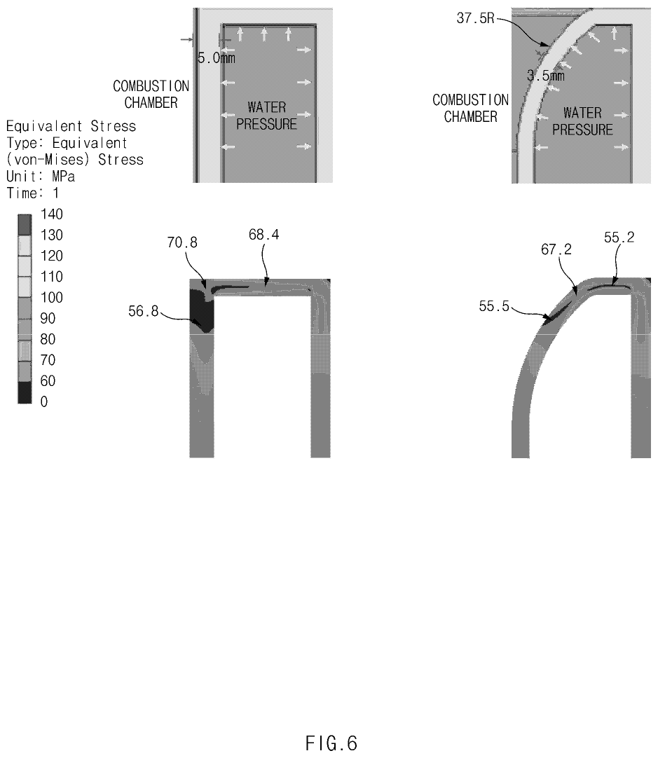

FIG. 6 is a view illustrating comparison of stress analysis results when the first part does not have a curvature and when the first part has a curvature. In more detail, the left side corresponds to the case, in which the first part 10 does not have a curvature, and the right side illustrates the case, in which a radius of curvature of the first part 10 is 37.5r. Furthermore, stresses applied when a pressure of 66 bar is applied to both sides are analyzed.

As illustrated in FIG. 6, it may be identified that the magnitudes of the applied stresses are similar in both cases. However, on the left side, the thickness corresponds to 5 mm, and on the right side, the thickness corresponds to 3.5 mm. That is, it may be understood that the anti-water pressure performance is maintained even though a smaller thickness is provided when the first part 10 has a curvature.

According to the present disclosure, because anti-water pressure performance that is of a level that is similar to that of the conventional technology may be maintained even though a smaller thickness is provided, costs may be reduced and a force that is necessary in a pressing operation also is reduced whereby manufacturing processes may become convenient.

Furthermore, according to the present disclosure, when the same thickness as that of the conventional technology is provided, a stronger anti-water pressure performance may be achieved.

Water Heater 1

Hereinafter, referring to the above-described drawings, the water heater 1 including the combustion chamber 4 for a water heater according to an embodiment of the present disclosure will be described in detail.

As illustrated in FIG. 1, the water heater 1 according to the embodiment of the present disclosure may include a tank 2, the burner 3, and the combustion chamber 4. The tank 2 is configured to keep water. As an example, the tank 2 may include an inlet 5, through which the water is introduced, and an outlet 6, through which the water is discharged. As illustrated in FIG. 1, the inlet 5 may be located on a lower side of the outlet 6, but the present disclosure is not necessarily limited thereto.

The burner 3 may be provided in the tank 2, and may be configured to cause a combustion reaction. The combustion chamber 4 may provide a space, in which the burner 3 may be disposed. The combustion chamber 4 may be opened upwards.

Method for Manufacturing Combustion Chamber

Hereinafter, a method for manufacturing the combustion chamber 4 for a water heater according to an embodiment of the present disclosure will be described in detail with reference to FIG. 5. The method for manufacturing the combustion chamber according to an embodiment of the present disclosure may include a pressing operation, a cutting operation, and a coupling operation.

The pressing operation may be an operation of making the cutting targeted object 40 having a shape that is opened upwards by pressing the upper surface of the flat plate downwards. As an example, it may be understood that pressing is performed in the pressing operation. It may be understood that the pressing operation is an operation of performing drawing.

The cutting operation may be an operation of cutting the cutting targeted object 40 along one surface that is perpendicular to the upward/downward direction to form the first part 10 and the second part 20. The coupling operation may be an operation of coupling the third part 30 between the first part 10 and the second part 20.

According to the present disclosure, because then upward/downward length of the combustion chamber for a water heater may be formed to be long, the cylinder type burner may be disposed therein whereby a heating performance may be enhanced.

Furthermore, according to the present disclosure, because one cutting targeted object is drawn and is cut to be utilized as parts of the combustion chamber, costs for molds may be reduced as compared with a drawing scheme.

Furthermore, according to the present disclosure, because the corners of the combustion chamber for a water heater are curved, the stresses generated by the water may be distributed uniformly whereby anti-water pressure performance may become better.

The above description is a simple exemplification of the technical spirits of the present disclosure, and the present disclosure may be variously corrected and modified by those skilled in the art to which the present disclosure pertains without departing from the essential features of the present disclosure. Accordingly, the embodiments disclosed in the present disclosure is not provided to limit the technical spirits of the present disclosure but provided to describe the present disclosure, and the scope of the technical spirits of the present disclosure is not limited by the embodiments. Accordingly, the technical scope of the present disclosure should be construed by the attached claims, and all the technical spirits within the equivalent ranges fall within the scope of the present disclosure.

What is claimed is:

1. A combustion chamber for a water heater provided in the water heater for heating water and configured to provide a space, in which a burner that causes a combustion reaction for heating the water is disposed, the combustion chamber comprising:
a first part, of which a first diameter that is a diameter of an upper end thereof is larger than a second diameter that is a diameter of a lower end thereof;
a second part, of which a diameter of an upper end is the same as the second diameter and of which a third diameter that is a diameter of a lower end thereof is smaller than the second diameter; and
a third part, of which an upper end is connected to the lower end of the first part and of which a lower end is connected to the upper end of the second part.

2. The combustion chamber of claim 1, wherein a diameter of the first part increases as it goes to an upper side, and a diameter increment rate that is a rate, at which the diameter per unit height increases, increases as it goes to the upper side.

3. The combustion chamber of claim 2, wherein the first part is curved.

4. The combustion chamber of claim 1, wherein a diameter of the second part increases as it goes to an upper side, and a diameter increment rate that is a rate, at which the diameter per unit height increases, decreases as it goes to the upper side.

5. The combustion chamber of claim 4, wherein the second part is curved.

6. The combustion chamber of claim 1, wherein the first part and the second part are formed by cutting and separating a cutting targeted object that is a single body.

7. The combustion chamber of claim 6, wherein the third part is coupled to the lower end of the first part and the upper end of the second part after the cutting targeted object is cut and separated into the first part and the second part.

8. The combustion chamber of claim 6, wherein the cutting targeted object is formed by pressing an upper surface of a flat plate downwards.

9. The combustion chamber of claim 1, wherein a plurality of holes, through which exhaust gas generated through the combustion reaction is discharged, are formed on a lower surface of the second part.

10. A water heater comprising:
a tank configured to keep water;
a combustion chamber provided in the tank, and configured to provide a space, in which a combustion reaction for heating the water is caused; and
a burner provided in the combustion chamber and configured to cause the combustion reaction,
wherein the combustion chamber is formed by coupling three parts of the combustion chamber, which are divided along an upward/downward direction, and a diameter of an upper end of the combustion chamber is larger than a diameter of a lower end thereof.

11. A method for manufacturing a combustion chamber, the method comprising:
pressing an upper surface of a flat plate downwards to make a cutting targeted object having a shape that is opened upwards;
cutting the cutting targeted object along one surface that is perpendicular to an upward/downward direction to form a first part and a second part; and
coupling a third part between the first part and the second part.
